(19) United States
(12) Patent Application Publication
(10) Pub. No.: US 2024/0405460 A1
(43) Pub. Date: Dec. 5, 2024

(54) BOARD-TO-BOARD CONNECTOR WITH IMPROVED CONDUCTIVE TERMINAL

(71) Applicant: Luxshare Precision Industry Company Limited, SHENZHEN (CN)

(72) Inventors: Chien-Yu HSU, SHENZHEN (CN); Hui-Hsueh CHIANG, SHENZHEN (CN); Shih-Tung LIN, SHENZHEN (CN)

(73) Assignee: Luxshare Precision Industry Company Limited, SHENZHEN (CN)

(21) Appl. No.: 18/582,912

(22) Filed: Feb. 21, 2024

(30) Foreign Application Priority Data
May 30, 2023 (CN) 202310626976.9

(51) Int. Cl. H01R 12/71; H01R 12/91; H01R 13/24; H01R 13/41

(52) U.S. Cl. CPC H01R 12/714; H01R 12/91; H01R 13/2435; H01R 13/41

(57) ABSTRACT

A board-to-board connector includes an insulating body and a conductive terminal. The conductive terminal includes a mounting portion, a first resilient arm and a second resilient arm. The mounting portion includes a main body portion and at least one tab protruding from the main body portion. The first resilient arm includes a first connecting portion, a first elastic arm, a first contact portion, a first extension arm and a first end portion. The second resilient arm includes a second connecting portion, a second elastic arm, a second contact portion, a second extension arm and a second end portion. When the first circuit board and the second circuit board abut against the corresponding first contact portion and the second contact portion, the first extension arm is in contact with the second end portion and/or the second extension arm is in contact with the first end portion.

### CROSS-REFERENCE TO RELATED APPLICATION

This patent application claims priority of a Chinese Patent Application No. 202310626976.9, filed on May 30, 2023 and titled “BOARD-TO-BOARD CONNECTOR”, the entire content of which is incorporated herein by reference.

### TECHNICAL FIELD

The present disclosure relates to a board-to-board connector, which belongs to a technical field of electrical connectors.

### BACKGROUND

A board-to-board connector is an electrical connector used to connect two circuit boards. The board-to-board connector usually includes an insulating body and a plurality of conductive terminals installed in the insulating body. Each conductive terminal includes a first resilient arm protruding beyond one side of the insulating body and a second resilient arm protruding beyond another side of the insulating body. The first resilient arm and the second resilient arm are used to abut against two circuit boards, respectively.

In the related art, the first resilient arm has a first free end, and the second resilient arm has a second free end. The first free end is always in contact with the second free end no matter whether the board-to-board connector abuts against the circuit boards or not. With the board-to-board connector continuously increasing the terminal density requirements, such a design in the related art will increase the mounting force of the circuit boards on the one hand, and on the other hand, it will easily crush the conductive terminals.

### SUMMARY

An object of the present disclosure is to provide a board-to-board connector with an improved structure of conductive terminal.

In order to achieve the above object, the present disclosure adopts the following technical solution: a board-to-board connector, including: an insulating body including a first mounting surface, a second mounting surface opposite to the first mounting surface, and at least one terminal accommodating groove extending through the first mounting surface and the second mounting surface along a thickness direction of the insulating body; and at least one conductive terminal including a mounting portion mounted to the insulating body, a first resilient arm extending integrally from one end of the mounting portion, and a second resilient arm extending integrally from another end of the mounting portion; the mounting portion including a main body portion and at least one tab protruding from the main body portion, the at least one tab engaging with the insulating body; wherein the first resilient arm includes a first connecting portion connected to the main body portion, a first elastic arm extending from the first connecting portion, a first contact portion extending integrally from the first elastic arm, a first extension arm extending integrally from the first contact portion, and a first end portion extending integrally from the first extension arm; the first contact portion is configured to protrude beyond the first mounting surface to abut against a first circuit board; the first extension arm extends toward the second mounting surface; wherein the second resilient arm includes a second connecting portion connected to the main body portion, a second elastic arm extending from the second connecting portion, a second contact portion extending integrally from the second elastic arm, a second extension arm extending integrally from the second contact portion, and a second end portion extending integrally from the second extension arm; the second contact portion is configured to protrude beyond the second mounting surface to abut against a second circuit board; the second extension arm extends toward the first mounting surface; when the first circuit board and the second circuit board are not in contact with corresponding first contact portion and the second contact portion, the first end portion is separated from the second end portion; when the first circuit board and the second circuit board abut against the corresponding first contact portion and the second contact portion for at least a period of time, the first resilient arm and the second resilient arm scrape each other; and when the first circuit board and the second circuit board abut against the corresponding first contact portion and the second contact portion, and the first circuit board and the second circuit board are mounted in place, the first extension arm is in contact with the second end portion and/or the second extension arm is in contact with the first end portion.

In order to achieve the above object, the present disclosure adopts the following technical solution: a board-to-board connector, including: an insulating body including a first mounting surface, a second mounting surface opposite to the first mounting surface, and at least one terminal accommodating groove extending through the first mounting surface and the second mounting surface along a thickness direction of the insulating body; and at least one conductive terminal including a mounting portion fixed to the insulating body, a first resilient arm extending from one end of the mounting portion, and a second resilient arm extending from another end of the mounting portion; the mounting portion including a main body portion and at least one tab protruding from the main body portion, the at least one tab engaging with the insulating body; wherein the first resilient arm includes a first connecting portion connected to the main body portion, a first elastic arm extending from the first connecting portion, a first contact portion extending from the first elastic arm, a first extension arm extending from the first contact portion, and a first end portion extending from the first extension arm; the first contact portion is configured to protrude beyond the first mounting surface along the thickness direction to abut against a first circuit board; the first extension arm extends toward the second mounting surface; wherein the second resilient arm includes a second connecting portion connected to the main body portion, a second elastic arm extending from the second connecting portion, a second contact portion extending from the second elastic arm, a second extension arm extending from the second contact portion, and a second end portion extending from the second extension arm; the second contact portion is configured to protrude beyond the second mounting surface along the thickness direction to abut against a second circuit board; the second extension arm extends toward the first mounting surface; when the first circuit board and the second circuit board are not in contact with corresponding first contact portion and the second contact portion, the first end portion is separated from the second end portion; when the first circuit board and the second circuit board abut against the corresponding first contact portion and the second contact portion for at least a period of time, the first resilient arm and the second resilient arm scrape each other along a lateral direction perpendicular to the thickness direction; and when the first circuit board and the second circuit board abut against the corresponding first contact portion and the second contact portion, and the first circuit board and the second circuit board are mounted in place, the first extension arm is in contact with the second end portion and/or the second extension arm is in contact with the first end portion.

Compared with the prior art, the present disclosure facilitates the mating of the conductive terminal and the insulating body by providing at least one tab. When the first circuit board and the second circuit board are not in contact with the corresponding first contact portion and the second contact portion, the first end portion and the second end portion are separated from each other. Therefore, the mounting force experienced by the first circuit board and the second circuit board at an initial stage of mounting is reduced. When the first circuit board and the second circuit board abut against the corresponding first contact portion and the second contact portion at least for a period of time, the first resilient arm and the second resilient arm scrape each other. On the one hand, a contact loop can be formed, and on the other hand, the contact force of the first resilient arm and the second resilient arm is reduced. When the first circuit board and the second circuit board abut against the corresponding first contact portion and the second contact portion, and are mounted in place, the first extension arm is in contact with the second end portion and/or the second extension arm is in contact with the first end portion, thereby improving the contact reliability.

### BRIEF DESCRIPTION OF DRAWINGS

FIG. 1 is a schematic perspective view of a board-to-board connector in accordance with a first embodiment of the present disclosure;

FIG. 2 is a front view of FIG. 1;

FIG. 3 is a partial perspective exploded view of FIG. 1, in which a conductive terminal is separated;

FIG. 4 is a partially enlarged view of a circled part A in FIG. 3;

FIG. 5 is a schematic perspective view of the conductive terminal in FIG. 4 in an initial state, wherein the conductive terminal is not abutted by a first circuit board and a second circuit board;

FIG. 6 is a schematic perspective view of the conductive terminal in FIG. 5 in a final abutting state, wherein the conductive terminal is abutted by the first circuit board and the second circuit board, and the first circuit board and the second circuit board are mounted in place;

FIG. 7 is a left view of FIG. 5;

FIG. 8 is a left view of the conductive terminal in FIG. 7 in an initial abutting state, wherein the conductive terminal is abutted by the first circuit board and the second circuit board, and the first resilient arm of the conductive terminal is in contact with the second resilient arm;

FIG. 9 is a left view of FIG. 6;

FIG. 10 is a schematic sectional view taken along line B-B in FIG. 1;

FIG. 11 is a partial enlarged view of a frame part C in FIG. 10;

FIG. 12 is a schematic cross-sectional view of the board-to-board connector in FIG. 10 when abutting against the first circuit board and the second circuit board, and the first circuit board and the second circuit board are mounted in place;

FIG. 13 is a partial enlarged view of a frame part D in FIG. 12;

FIG. 14 is a schematic perspective view of the conductive terminal in FIG. 5 in accordance with a second embodiment of the present disclosure, wherein the conductive terminal is not abutted by the first circuit board and the second circuit board;

FIG. 15 is a schematic perspective view of the conductive terminal in FIG. 14 in the final abutting state, wherein the conductive terminal is abutted by the first circuit board and the second circuit board, and the first circuit board and the second circuit board are mounted in place;

FIG. 16 is a left view of FIG. 15;

FIG. 17 is a schematic cross-sectional view of the board-to-board connector taken along line B-B in FIG. 1 in the second embodiment;

FIG. 18 is a partial enlarged view of a frame part E in FIG. 17;

FIG. 19 is a schematic perspective view of the conductive terminal in FIG. 5 in accordance with a third embodiment of the present disclosure, wherein the conductive terminal is not abutted by the first circuit board and the second circuit board;

FIG. 20 is a schematic perspective view of the conductive terminal in FIG. 19 in the final abutting state, wherein the conductive terminal is abutted by the first circuit board and the second circuit board, and the first circuit board and the second circuit board are mounted in place;

FIG. 21 is a schematic perspective view of the conductive terminal in FIG. 5 in accordance with a fourth embodiment of the present disclosure, wherein the conductive terminal is not abutted by the first circuit board and the second circuit board;

FIG. 22 is a schematic perspective view of the conductive terminal in FIG. 21 in the final abutting state, wherein the conductive terminal is abutted by the first circuit board and the second circuit board, and the first circuit board and the second circuit board are mounted in place; and

FIG. 23 is a left side view of the conductive terminal in accordance with a fifth embodiment of the present disclosure in the final abutting state, wherein the conductive terminal is abutted by the first circuit board and the second circuit board, and the first circuit board and the second circuit board are mounted in place.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

The present disclosure discloses a board-to-board connector 100 configured to connect a first circuit board 200 and a second circuit board 300. The first circuit board 200 and the second circuit board 300 are located at two sides (for example, upper and lower sides) of the board-to-board connector 100, respectively. The first circuit board 200 is provided with a plurality of first conductive pads (not shown). The second circuit board 300 is provided with a plurality of second conductive pads (not shown).

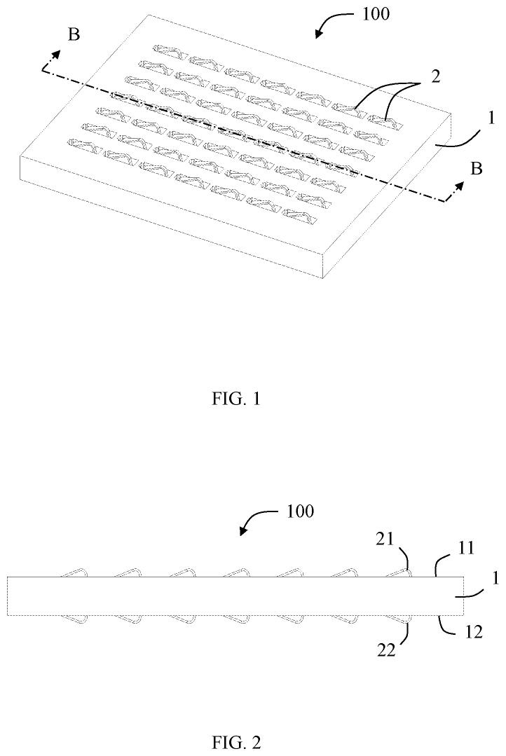

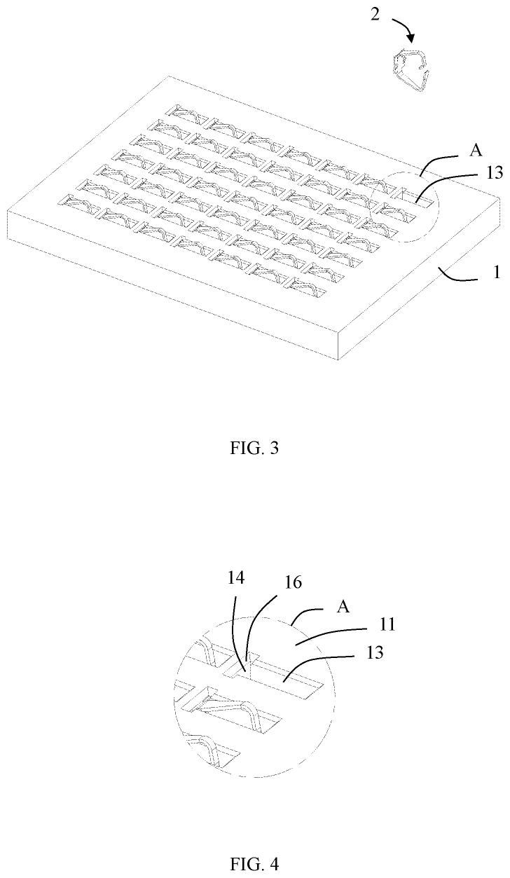

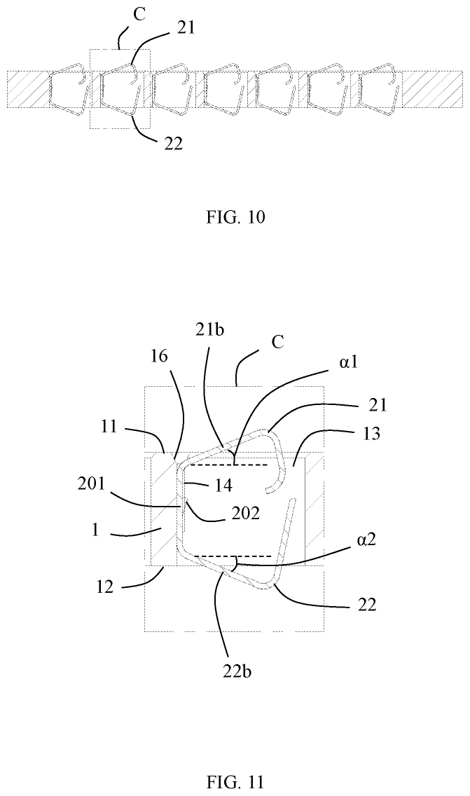

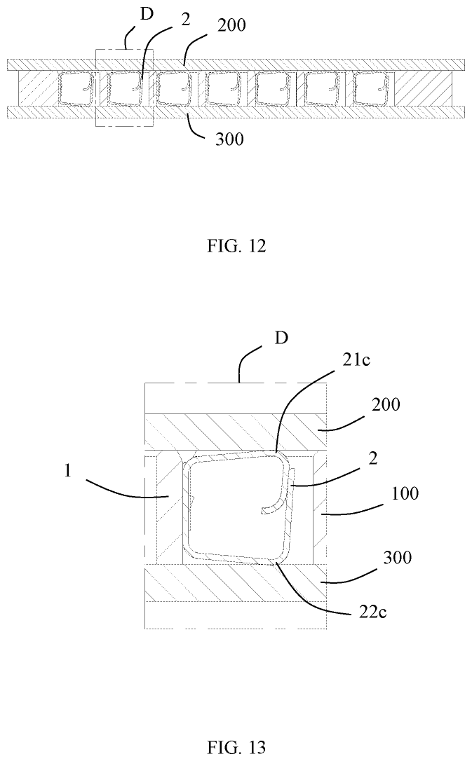

Referring to FIG. 1 to FIG. 13, in a first embodiment of the board-to-board connector 100 disclosed in the present disclosure, the board-to-board connector 100 includes an insulating body 1 and a plurality of conductive terminals 2 mounted to the insulating body 1. The plurality of conductive terminals 2 are configured to be in contact with the plurality of first conductive pads of the first circuit board 200 and the plurality of second conductive pads of the second circuit board 300, so as to realize the electrical connection between the first circuit board 200 and the second circuit board 300.

Referring to FIG. 2 to FIG. 4, in the embodiment shown in the present disclosure, the insulating body 1 is flat, which includes a first mounting surface 11 (for example, an upper surface), a second mounting surface 12 (for example, a lower surface) opposite to the first mounting surface 11, and a plurality of terminal accommodating grooves 13 extending through the first mounting surface 11 and the second mounting surface 12 along a thickness direction (for example, a top-bottom direction) of the insulating body 1. In the illustrated embodiment of the present disclosure, the first mounting surface 11 and the second mounting surface 12 are parallel to each other.

Besides, the insulating body 1 further includes a plurality of mounting slots 14 extending through the first mounting surface 11. The mounting slots 14 communicate with corresponding terminal accommodating grooves 13. The insulating body 1 further includes a plurality of guiding inclined surfaces 16 communicating with the mounting slots 14 and exposed to the first mounting surface 11. The plurality of guiding inclined surfaces 16 form a bell mouth to better guide the assembly of the conductive terminals 2 when assembling the conductive terminals 2 to the insulating body 1.

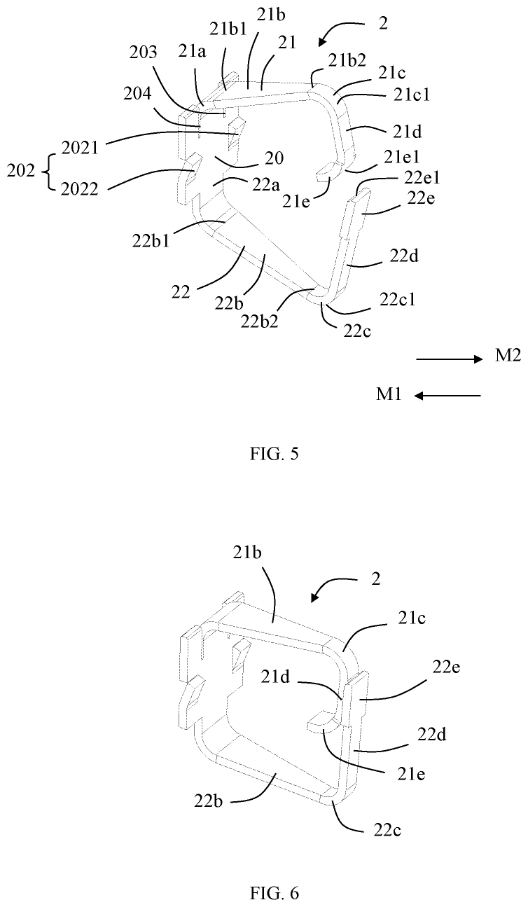

In the illustrated embodiment of the present disclosure, the plurality of conductive terminals 2 are arranged in a matrix, for example, in a 7*7 matrix. Of course, in other embodiments, the arrangement of the plurality of conductive terminals 2 can be flexibly adjusted as required. Referring to FIG. 5 to FIG. 13, in the embodiment shown in the present disclosure, each conductive terminal 2 has the same structure, which includes a mounting portion 20 mounted to the insulating body 1, a first resilient arm 21 extending integrally from one end of the mounting portion 20, and a second resilient arm 22 extending integrally from another end of the mounting portion 20.

The mounting portion 20 includes a main body portion 201 received in the mounting slot 14 and at least one tab 202 protruding from the main body portion 201 laterally (for example, to the left or to the right). The mounting portion 20 is fixed to the insulating body 1, or the mounting portion 20 is floatable along the thickness direction of the insulating body 1. In the first embodiment of the present disclosure, the tab 202 protrudes from the main body portion 201 along a second direction M2 opposite to a first direction M1. Specifically, the tab 202 includes a first tab 2021 and a second tab 2022. The first tab 2021 and the second tab 2022 are located at two ends (for example, front and rear ends) of the main body portion 201. The first tab 2021 and the second tab 2022 protrude from the main body portion 201 along the second direction M2.

In the first embodiment shown in the present disclosure, the first tab 2021 and the second tab 2022 are formed on two sides of the main body portion 201 by stamping. With such setting, on the one hand, it is beneficial to maximize the distance between the first tab 2021 and the second tab 2022 in a front-rear direction, thereby improving the installation stability. On the other hand, it is beneficial to reduce the impact on the structural strength of the main body portion 201 when molding the first tab 2021 and the second tab 2022.

In the first embodiment shown in the present disclosure, the main body portion 201 is located in the mounting slot 14. The first tab 2021 and the second tab 2022 are in hard interference fit with the insulating body 1, so that the mounting portion 20 is fixed to the insulating body 1.

The first resilient arm 21 includes a first connecting portion 21a connected to the main body portion 201, a first elastic arm 21b extending from the first connecting portion 21a, a first contact portion 21c extending integrally from the first elastic arm 21b, a first extension arm 21d extending integrally from the first contact portion 21c, and a first end portion 21e extending integrally from the first extension arm 21d.

The mounting portion 20 includes a first slit 203 and a second slit 204 formed on the main body portion 201. The first connecting portion 21a is located between the first slit 203 and the second slit 204. With such arrangement, a length of the first resilient arm 21 can be appropriately increased, thereby improving the elasticity of the first resilient arm 21. In one embodiment of the present disclosure, both the first slit 203 and the second slit 204 are tear seams left when forming the first resilient arm 21. It is understandable to those skilled in the art that widths of the first slit 203 and the second slit 204 can be flexibly adjusted as required. In some embodiments, the first slit 203 and the second slit 204 are narrower. In other embodiments, the first slit 203 and the second slit 204 may be slightly wider.

The first elastic arm 21b includes a first end 21b1 connected to the first connecting portion 21a and a second end 21b2 connected to the first contact portion 21c. A width of the second end 21b2 is smaller than a width of the first end 21b1. In the illustrated embodiment of the present disclosure, the width of the first elastic arm 21b gradually decreases from the first end 21b1 to the second end 21b2. This design is beneficial to reduce the mounting force when the first circuit board 200 abuts against the first resilient arm 21. The first elastic arm 21b is located between the first tab 2021 and the second tab 2022.

The first contact portion 21c is configured to protrude beyond the first mounting surface 11 to abut against the first conductive pad of the first circuit board 200. In the illustrated embodiment of the present disclosure, the first contact portion 21c has an arc-shaped first contact surface 21c1 to reduce the scratch when abutting against the first conductive pad of the first circuit board 200.

The first extension arm 21d extends toward the second mounting surface 12. In the illustrated embodiment of the present disclosure, the first extension arm 21d extends obliquely toward the second mounting surface 12.

The first end portion 21e is located adjacent to an end of the first resilient arm 21. In the illustrated embodiment of the present disclosure, the first end portion 21e is located at a free end of the first resilient arm 21. A width of the first end portion 21e is greater than a width of the first extension arm 21d connected to the first end portion 21e, so as to increase the contact area and improve the reliability when mating with the second resilient arm 22. The first end portion 21e includes a first guiding surface 21e1. The first guiding surface 21e1 is an inclined surface or an arc surface. In the illustrated embodiment of the present disclosure, the first guiding surface 21e1 is an arc surface.

The second resilient arm 22 includes a second connecting portion 22a connected to the main body portion 201, a second elastic arm 22b extending from the second connecting portion 22a, a second contact portion 22c extending integrally from the second elastic arm 22b, a second extension arm 22d extending integrally from the second contact portion 22c, and a second end portion 22e extending integrally from the second extension arm 22d.

The second connecting portion 22a extends integrally with the main body portion 201.

The second elastic arm 22b includes a third end 22b1 connected to the second connecting portion 22a and a fourth end 22b2 connected to the second contact portion 22c. A width of the fourth end 22b2 is smaller than a width of the third end 22b1. In the illustrated embodiment of the present disclosure, the width of the second elastic arm 22b gradually decreases from the third end 22b1 to the fourth end 22b2. This design is beneficial to reduce the mounting force when the second circuit board 300 abuts against the second resilient arm 22.

The second contact portion 22c is configured to protrude beyond the second mounting surface 12 to abut against the second conductive pad of the second circuit board 300. In the illustrated embodiment of the present disclosure, the second contact portion 22c has an arc-shaped second contact surface 22c1 to reduce the scratch when abutting against the second conductive pad of the second circuit board 300.

The second extension arm 22d extends toward the first mounting surface 11. In the illustrated embodiment of the present disclosure, the second extension arm 22d extends obliquely toward the first mounting surface 11.

The second end portion 22e is located adjacent to an end of the second resilient arm 22. In the illustrated embodiment of the present disclosure, the second end portion 22e is located at a free end of the second resilient arm 22. A width of the second end portion 22e is greater than a width of the second extension arm 22d connected to the second end portion 22e, so as to increase the contact area and improve the reliability when mating with the first end portion 21e. The second end portion 22e includes a second guiding surface 22e1 located on an inner side thereof. The second guiding surface 22e1 is an inclined surface or an arc surface. In the first embodiment shown in the present disclosure, the second guiding surface 22e1 is an inclined surface, and the inclined surface is formed by a chamfered inner surface. In another embodiment of the present disclosure, the second guiding surface 22e1 is an arc surface, and the arc surface is formed by a rounded inner surface. The first guiding surface 21e1 is configured to cooperate with the second guiding surface 22e1.

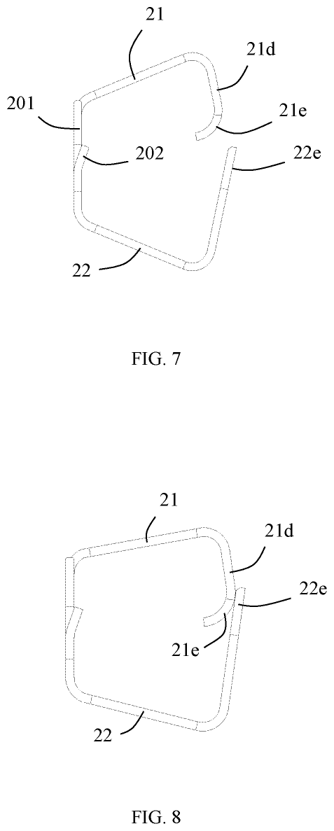

Referring to FIG. 5 and FIG. 7, when the first circuit board 200 and the second circuit board 300 are not in contact with the corresponding first contact portion 21c and the second contact portion 22c, the first end portion 21e and the second end portion 22e are separated from each other. This design is beneficial to reduce the mounting force on the first circuit board 200 and the second circuit board 300 at an initial stage of mounting.

Referring to FIG. 8, when the first circuit board 200 and the second circuit board 300 abut against the corresponding first contact portion 21c and the second contact portion 22c at least for a period of time, the first resilient arm 21 and the second resilient arm 22 scrape each other along a lateral direction. This lateral scraping is also beneficial to reduce the scraping force of the first contact portion 21c and the second contact portion 22c while realizing the contact of the first contact portion 21c and the second contact portion 22c, so as to avoid excessive deformation of the conductive terminal 2. In the illustrated embodiment of the present disclosure, the lateral direction is an extending direction of the first elastic arm 21b or the second extension arm 22d itself, such as a horizontal direction (horizontally left or horizontally right).

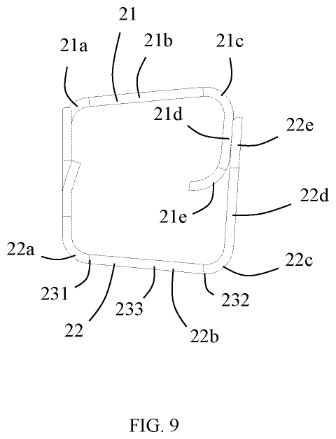

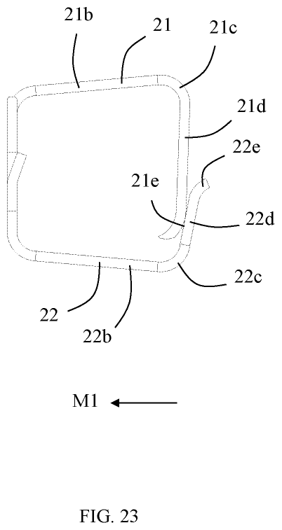

Referring to FIG. 6 and FIG. 9, when the first circuit board 200 and the second circuit board 300 abut against the corresponding first contact portion 21c and the second contact portion 22c, and the first circuit board 200 and the second circuit board 300 are mounted in place, the first extension arm 21d and the second end portion 22e are in contact with each other along the lateral direction (for example, attached to each other, as shown in FIG. 9) and/or the second extension arm 22d and the first end portion 21e are in contact with each other along the lateral direction (for example, attached to each other, as shown in FIG. 23). At this time, the conductive terminal 2 is in a shape of a closed frame, realizing the electrical connection between the first circuit board 200 and the second circuit board 300. At this time, the first extension arm 21d is located inside the second end portion 22e along the first direction M1.

Referring to FIG. 11, when the first circuit board 200 and the second circuit board 300 are not in contact with the corresponding first contact portion 21c and the second contact portion 22c, a first included angle α1 is formed between the first elastic arm 21b extending obliquely upward and the first mounting surface 11, and a second included angle α2 is formed between the second elastic arm 22b extending obliquely downward and the second mounting surface 12. The first included angle α1 is equal to the second included angle α2.

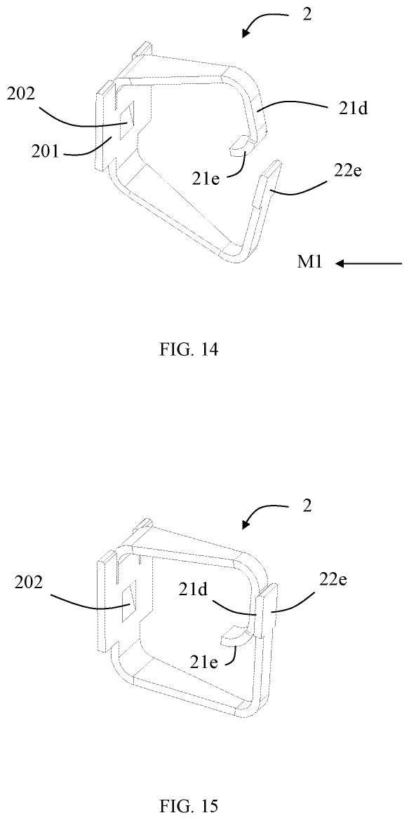

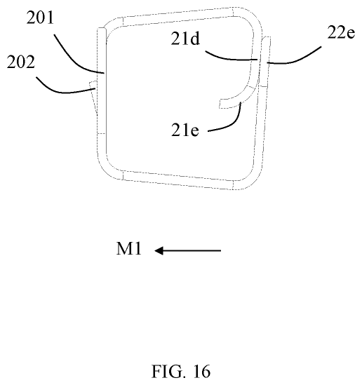

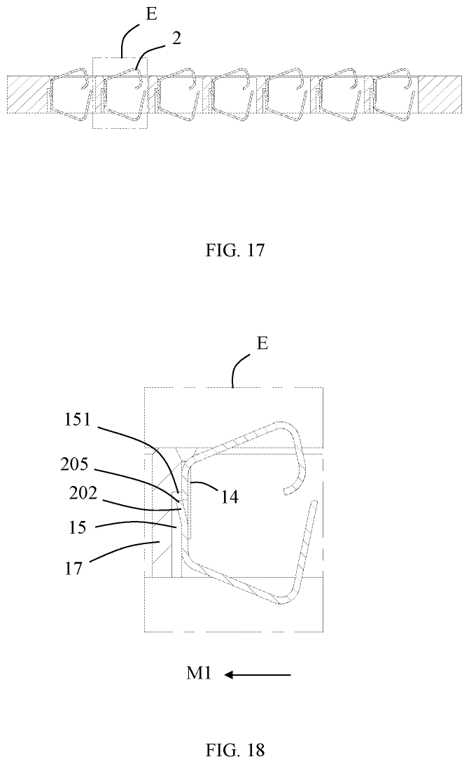

Referring to FIG. 14 to FIG. 18, in a second embodiment of the board-to-board connector 100 of the present disclosure, the insulating body 1 further includes a plurality of blind slots 15 communicating with corresponding mounting slots 14. The mounting slot 14 communicates with a corresponding terminal accommodating groove 13. The mounting slot 14 is located between the blind slot 15 communicating with the mounting slot 14 and the terminal accommodating groove 13 communicating with the mounting slot 14. It is understandable to those skilled in the art that the so-called “blind slot” means that the slot does not extend through a certain surface. In the illustrated embodiment of the present disclosure, the blind slot 15 does not extend upwardly through the first mounting surface 11. The insulating body 1 includes an abutting wall surface 151 at a top of the blind slot 15.

In the second embodiment of the present disclosure, each conductive terminal 2 is only provided with one tab 202 located in a middle of the main body portion 201. The tab 202 is accommodated in the blind slot 15 to cooperate with the insulating body 1. Preferably, the tab 202 is stamped from the middle of the main body portion 201. The tab 202 protrudes from the main body portion 201 along the first direction M1. The blind slot 15 is located outside the mounting slot 14. The tab 202 has a top edge 205. The top edge 205 and the abutting wall surface 151 are spaced apart in the thickness direction of the insulating body 1. That is, there is a distance between the top edge 205 and the abutting wall surface 151 in the thickness direction of the insulating body 1. In this way, the mounting portion 20 is floatable along the thickness direction of the insulating body 1, so as to adjust the abutment force of the first circuit board 200 and the second circuit board 300 when abutting against the first contact portion 21c and the second contact portion 22c. Of course, it is understandable to those skilled in the art that even if the mounting portion 20 is floatable along the thickness direction of the insulating body 1, when the top edge 205 of the tab 202 abuts against the abutting wall surface 151, the mounting portion 20 is located at the highest limit position. The mounting portion 20 will not be detached from the insulating body 1 anyway.

It is understandable to those skilled in the art that, in the second embodiment of the present disclosure, the position and the protruding direction of the tab 202 need to mate with the blind slot 15 and the abutting wall surface 151 formed on a partition wall 17 between two adjacent terminal accommodating grooves 13. This design poses a great challenge to the structural strength of the partition wall 17. In the first embodiment of the present disclosure, the position and protruding direction of the first tab 2021 and the second tab 2022 correspond to a thicker portion of the insulating body 1, so that the impact on the structural strength of the insulating body 1 is reduced as much as possible.

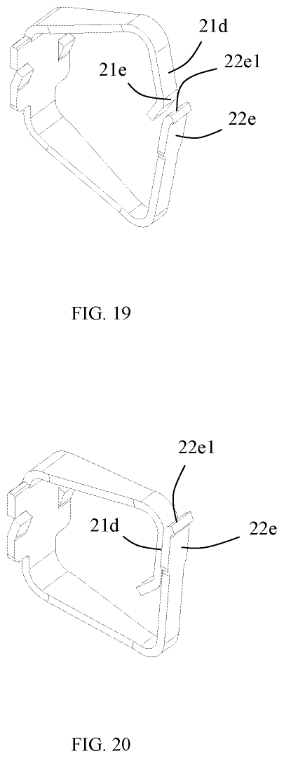

Referring to FIG. 19 and FIG. 20, in a third embodiment of the present disclosure, a free end of the second end portion 22e is generally deflected outward toward a side away from the first resilient arm 21. The second end portion 22e includes a second guiding surface 22e1 located inside to guide the first end portion 21e of the first resilient arm 21. The second guiding surface 22e1 is an inclined surface or an arc surface. In the third embodiment shown in the present disclosure, the second guiding surface 22e1 is an arc surface.

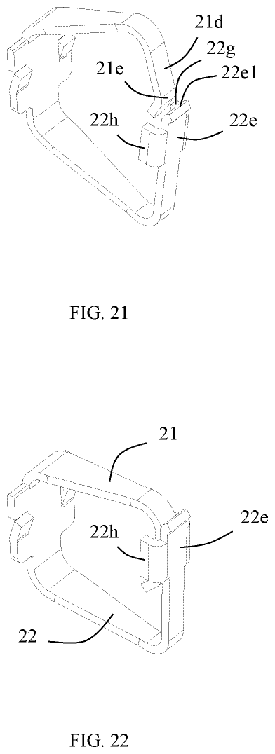

Referring to FIG. 21 and FIG. 22, in a fourth embodiment of the present disclosure, the second resilient arm 22 includes a first limiting block 22g and a second limiting block 22h. The first limiting block 22g and the second limiting block 22h are used to limit the first resilient arm 21. When the first circuit board 200 and the second circuit board 300 abut against the corresponding first contact portion 21c and the second contact portion 22c, the first extension arm 21d is restricted between the first limiting block 22g and the second limiting block 22h.

It is understandable to those skilled in the art that the methods of mounting the first circuit board 200 and the second circuit board 300 to the board-to-board connector 100 roughly include the following three types:
a first type: the first circuit board 200 and the second circuit board 300 abut against the board-to-board connector 100 at the same time; at this time, the first resilient arm 21 and the second resilient arm 22 deform almost simultaneously;
a second type: the first circuit board 200 abuts against the board-to-board connector 100 prior to the second circuit board 300; at this time, the first resilient arm 21 is deformed prior to the second resilient arm 22; and
a third type: the second circuit board 300 abuts against the board-to-board connector 100 prior to the first circuit board 200; at this time, the second resilient arm 22 is deformed prior to the first resilient arm 21.

Referring to FIG. 7 to FIG. 9, in the process of deformation of the first resilient arm 21 and the second elastic arm 22, a position where the first elastic arm 21b is connected to the first connecting portion 21a is the most important supporting point of the first resilient arm 21. Therefore, when the first circuit board 200 is mounted in place, the force on the supporting point is greater than that on other positions of the first elastic arm 21; and the closer the position is located to the supporting point, the greater the force becomes.

Similarly, a position where the second elastic arm 22b is connected to the second connecting portion 22a is the most important supporting point of the second resilient arm 22. Therefore, when the second circuit board 300 is mounted in place, the force on the supporting point is greater than that on other positions of the second resilient arm 22. Taking the second resilient arm 22 as an example to describe in detail, the second elastic arm 22b includes a first portion 231 connected to the second connecting portion 22a, a second portion 232 connected to the second contact portion 22c, and an intermediate portion 233 located between the first portion 231 and the second portion 232. When the second circuit board 300 is mounted in place, the force on the first portion 231 is greater than that on the second portion 232, and the force on the second portion 232 is greater than that of the intermediate portion 233.

Compared with the prior art, the present disclosure facilitates the cooperation of the conductive terminal 2 and the insulating body 1 by providing at least one tab 202. When the first circuit board 200 and the second circuit board 300 are not in contact with the corresponding first contact portion 21c and the second contact portion 22c, the first end portion 21e and the second end portion 22e are separated from each other. Therefore, the mounting force experienced by the first circuit board 200 and the second circuit board 300 at an initial stage of mounting is reduced. When the first circuit board 200 and the second circuit board 300 abut against the corresponding first contact portion 21c and the second contact portion 22c at least for a period of time, the first resilient arm 21 and the second resilient arm 22 scrape each other. On the one hand, a contact loop can be formed, and on the other hand, the contact force of the first resilient arm 21 and the second resilient arm 22 is reduced. When the first circuit board 200 and the second circuit board 300 are in contact with the corresponding first contact portion 21c and the second contact portion 22c, and are mounted in place, the first extension arm 21d is in contact with the second end portion 22e and/or the second extension arm 22d is in contact with the first end portion 21e, thereby improving the contact reliability.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A board-to-board connector, comprising:
an insulating body comprising a first mounting surface, a second mounting surface opposite to the first mounting surface, and at least one terminal accommodating groove extending through the first mounting surface and the second mounting surface along a thickness direction of the insulating body; and
at least one conductive terminal comprising a mounting portion mounted to the insulating body, a first resilient arm extending integrally from one end of the mounting portion, and a second resilient arm extending integrally from another end of the mounting portion; the mounting portion comprising a main body portion and at least one tab protruding from the main body portion, the at least one tab engaging with the insulating body;
wherein the first resilient arm comprises a first connecting portion connected to the main body portion, a first elastic arm extending from the first connecting portion, a first contact portion extending integrally from the first elastic arm, a first extension arm extending integrally from the first contact portion, and a first end portion extending integrally from the first extension arm; the first contact portion is configured to protrude beyond the first mounting surface to abut against a first circuit board; the first extension arm extends toward the second mounting surface;
wherein the second resilient arm comprises a second connecting portion connected to the main body portion, a second elastic arm extending from the second connecting portion, a second contact portion extending integrally from the second elastic arm, a second extension arm extending integrally from the second contact portion, and a second end portion extending integrally from the second extension arm; the second contact portion is configured to protrude beyond the second mounting surface to abut against a second circuit board; the second extension arm extends toward the first mounting surface;
when the first circuit board and the second circuit board are not in contact with corresponding first contact portion and the second contact portion, the first end portion is separated from the second end portion;
when the first circuit board and the second circuit board abut against the corresponding first contact portion and the second contact portion for at least a period of time, the first resilient arm and the second resilient arm scrape each other; and
when the first circuit board and the second circuit board abut against the corresponding first contact portion and the second contact portion, and the first circuit board and the second circuit board are mounted in place, the first extension arm is in contact with the second end portion and/or the second extension arm is in contact with the first end portion.

2. The board-to-board connector according to claim 1, wherein the first end portion is located at a free end of the first resilient arm; and the second end portion is located at a free end of the second resilient arm.

3. The board-to-board connector according to claim 1, wherein the first end portion comprises a first guiding surface configured to guide the second resilient arm; the second end portion comprises a second guiding surface configured to guide the first resilient arm; the first guiding surface is an inclined surface or an arc surface; and the second guiding surface is an inclined surface or an arc surface.

4. The board-to-board connector according to claim 1, wherein when the first circuit board and the second circuit board abut against the corresponding first contact portion and the second contact portion, and the first circuit board and the second circuit board are mounted in place, the first extension arm is located inside the second end portion along a first direction.

5. The board-to-board connector according to claim 4, wherein the at least one protrudes from the main body portion along the first direction; or
the at least one tab protrudes from the main body portion along a second direction opposite to the first direction.

6. The board-to-board connector according to claim 5, wherein only one tab is provided and located in a middle of the main body portion; the tab protrudes from the main body portion along the first direction.

7. The board-to-board connector according to claim 5, wherein the at least one tab comprises a first tab and a second tab; the first tab and the second tab are located at two sides of the main body portion; the first tab and the second tab protrude from the main body along the second direction.

8. The board-to-board connector according to claim 1, wherein the mounting portion is fixed to the insulating body, or the mounting portion is floatable along the thickness direction of the insulating body.

9. The board-to-board connector according to claim 8, wherein the insulating body comprises a mounting slot extending through the first mounting surface and communicating with the terminal accommodating groove, and a blind slot located outside the mounting slot; the main body portion is located in the mounting slot; the at least one tab is located in the blind slot; the insulating body comprises an abutting wall surface at a top of the blind slot; the at least one tab comprises a top edge; and the top edge and the abutting wall surface are disposed at intervals in the thickness direction of the insulating body.

10. The board-to-board connector according to claim 7, wherein the insulating body comprises a mounting slot extending through the first mounting surface and communicating with the terminal accommodating groove; the main body portion is located in the mounting slot; the first tab and the second tab are in hard interference fit with the insulating body; the first elastic arm is located between the first tab and the second tab.

11. The board-to-board connector according to claim 1, wherein a width of the first end portion is greater than a width of the first extension arm connected to the first end portion; a width of the second end portion is greater than a width of the second extension arm connected to the second end portion.

12. The board-to-board connector according to claim 1, wherein the first elastic arm comprises a first end connected to the first connecting portion and a second end connected to the first contact portion; a width of the second end is smaller than a width of the first end; and
wherein the second elastic arm comprises a third end connected to the second connecting portion and a fourth end connected to the second contact portion; a width of the fourth end is smaller than a width of the third end.

13. The board-to-board connector according to claim 1, wherein the mounting portion comprises a first slit and a second slit which are formed on the main body portion; the first connecting portion is located between the first slit and the second slit.

14. The board-to-board connector according to claim 1, wherein the second resilient arm comprises a first limiting block and a second limiting block which extending integrally from two sides of the second end portion, respectively;
when the first circuit board and the second circuit board abut against the corresponding first contact portion and the second contact portion, and the first circuit board and the second circuit board are mounted in place, the first extension arm is restricted between the first limiting block and the second limiting block.

15. A board-to-board connector, comprising:
an insulating body comprising a first mounting surface, a second mounting surface opposite to the first mounting surface, and at least one terminal accommodating groove extending through the first mounting surface and the second mounting surface along a thickness direction of the insulating body; and
at least one conductive terminal comprising a mounting portion immovably fixed to the insulating body, a first resilient arm extending from one end of the mounting portion, and a second resilient arm extending from another end of the mounting portion; the mounting portion comprising a main body portion and at least one tab protruding from the main body portion, the at least one tab engaging with the insulating body;
wherein the first resilient arm comprises a first connecting portion connected to the main body portion, a first elastic arm extending from the first connecting portion, a first contact portion extending from the first elastic arm, a first extension arm extending from the first contact portion, and a first end portion extending from the first extension arm; the first contact portion is configured to protrude beyond the first mounting surface along the thickness direction to abut against a first circuit board; the first extension arm extends toward the second mounting surface;
wherein the second resilient arm comprises a second connecting portion connected to the main body portion, a second elastic arm extending from the second connecting portion, a second contact portion extending from the second elastic arm, a second extension arm extending from the second contact portion, and a second end portion extending from the second extension arm; the second contact portion is configured to protrude beyond the second mounting surface along the thickness direction to abut against a second circuit board; the second extension arm extends toward the first mounting surface;
when the first circuit board and the second circuit board are not in contact with corresponding first contact portion and the second contact portion, the first end portion is separated from the second end portion;
when the first circuit board and the second circuit board abut against the corresponding first contact portion and the second contact portion for at least a period of time, the first resilient arm and the second resilient arm scrape each other along a lateral direction perpendicular to the thickness direction; and
when the first circuit board and the second circuit board abut against the corresponding first contact portion and the second contact portion, and the first circuit board and the second circuit board are mounted in place, the first extension arm is in contact with the second end portion and/or the second extension arm is in contact with the first end portion.

16. The board-to-board connector according to claim 15, wherein the first end portion is located at a free end of the first resilient arm; and the second end portion is located at a free end of the second resilient arm.

17. The board-to-board connector according to claim 15, wherein when the first circuit board and the second circuit board abut against the corresponding first contact portion and the second contact portion, and the first circuit board and the second circuit board are mounted in place, the first extension arm is located inside the second end portion along a first direction.

18. The board-to-board connector according to claim 17, wherein the at least one protrudes from the main body portion along the first direction; or
the at least one tab protrudes from the main body portion along a second direction opposite to the first direction.

19. The board-to-board connector according to claim 15, wherein a width of the first end portion is greater than a width of the first extension arm connected to the first end portion; a width of the second end portion is greater than a width of the second extension arm connected to the second end portion.

20. The board-to-board connector according to claim 15, wherein the second resilient arm comprises a first limiting block and a second limiting block which extending integrally from two sides of the second end portion, respectively;
when the first circuit board and the second circuit board abut against the corresponding first contact portion and the second contact portion, and the first circuit board and the second circuit 10 board are mounted in place, the first extension arm is restricted between the first limiting block and the second limiting block.
